(19) United States
(12) Patent Application Publication
(10) Pub. No.: US 2016/0116438 A1
(43) Pub. Date: Apr. 28, 2016

(54) DROPLET ACTUATOR AND METHODS

(71) Applicant: ADVANCED LIQUID LOGIC, INC., San Diego, CA (US)

(72) Inventors: Vamsee K. Pamula, Cary, NC (US); Vijay Srinivasan, Cary, NC (US)

(73) Assignee: Advanced Liquid Logic, Inc., San Diego, CA (US)

(21) Appl. No.: 14/895,788

(22) PCT Filed: Jun. 13, 2014
(86) PCT No.: PCT/US14/42290

§ 371 Date: Dec. 3, 2015

Related U.S. Application Data
(60) Provisional application No. 61/834,942, filed on Jun. 14, 2013.

(51) Int. Cl. G01N 27/447; B01L 3/00

(52) U.S. Cl. CPC G01N 27/44791; B01L 3/502792; G01N 27/44704; B01L 2400/0427; B01L 2300/165; B01L 2200/0673

(57) ABSTRACT

The invention provides a droplet actuator designed to provide reliable electrical connections to droplets to reduce or eliminate gas bubble formation during droplet operations. The invention also provides methods and systems for reducing or eliminating the formation of bubbles in a droplet during droplet operations.

### RELATED APPLICATIONS

In addition to the patent applications cited herein, each of which is incorporated herein by reference, this patent application is related to and claims priority to U.S. Provisional Patent Application No. 61/834,942, filed on Jun. 14, 2013, entitled “Droplet Actuator Actuator and Methods;” the entire disclosure of which is incorporated herein by reference.

### FIELD OF THE INVENTION

The present invention generally relates to droplet actuators and methods for their use. In particular, the present invention provides a droplet actuator designed for providing reliable electrical connections to droplets to reduce or eliminate gas bubble formation.

### BACKGROUND

A droplet actuator typically includes one or more substrates configured to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets. Bubble formation in a droplet actuator during droplet operations can be a severe problem. There is a need for new approaches to reducing or preventing gas bubbles from forming in droplet actuators.

### BRIEF DESCRIPTION OF THE DRAWINGS

FIGS. 1 through 10B illustrate various views of a droplet actuator that includes a droplet operations channel, wherein the sidewalls of the droplet operations channel includes electrode arrangements to assist the droplet to be in reliable contact with the ground reference of the droplet actuator;

FIG. 11 illustrates a plan view and a cross-sectional view of a droplet actuator and showing another example of a droplet operations channel;

FIG. 12 illustrates a plan view of an electrode arrangement in which droplet operations electrodes and ground reference electrodes are staggered from one another and spaced widely apart;

FIGS. 13A, 13B, and 13C illustrate plan views of an electrode arrangement in which the electrodes along the droplet operations channel can be dynamically switched between an electrowetting voltage and electrical ground;

FIG. 14 illustrates a plan view of an electrode arrangement in which the droplet operations electrodes are arranged on each side of the droplet operations channel and a set of ground reference electrodes are arranged within the droplet operations channel;

FIGS. 15A and 15B illustrate plan views an electrode arrangement that includes a droplet operations channel in which droplet splitting operations can occur via droplet operations;

FIGS. 16A and 16B illustrate a plan view of an electrode arrangement in which electrodes are arranged to facilitate the movement of droplets into a droplet splitting region that utilizes the electrode arrangement of FIGS. 15A and 15B;

FIGS. 17A and 17B illustrate a plan view and a cross-sectional view, respectively, of a portion of a droplet actuator that includes an arrangement of electrode pins;

FIGS. 18A through 22C show examples of using the independently controlled electrode pins of FIGS. 17A and 17B to perform various droplet operations, such as droplet splitting, merging, transporting, and dispensing operations; and

FIG. 23 illustrates a functional block diagram of an example of a microfluidics system that includes a droplet actuator.

### BRIEF DESCRIPTION

The invention provides a droplet actuator comprising: a) a top substrate and a bottom substrate separated to form a droplet operations gap; wherein the bottom substrate comprises a first rail and a second rail separated to form a droplet operations channel; b) droplet operations electrodes atop a side of the first rail, wherein the side of the first rail faces the droplet operations channel; and c) one or more counter-electrodes atop a side of the second rail, wherein the side of the second rail faces the droplet operations channel; wherein the droplet operations electrodes are arranged to maintain contact between a droplet and the one or more counter-electrodes during droplet operations. In some embodiments, the droplet operations electrodes comprise an array of independently controlled electrode pins. In other embodiments, the one or more counter-electrodes comprise ground electrodes.

In certain embodiments, the first rail and the second rail of the droplet actuator are each elongated three-dimensional (3D) structures. In still further embodiments, the side of the first rail and the side of second rail each provide a droplet operations surface. In another embodiment, the droplet operations channel, the first rail, and the second rail each have a height h, and wherein the droplet operations channel has a width w. In yet another embodiment, height h and width w are set according to the volume of the droplet such that contact is maintained between the droplet and the one or more counter-electrodes during droplet operations, particularly wherein the droplet is a sub-micron sized droplet, and more particularly wherein a hydrophobic coating is provided atop the one or more counter-electrodes and the droplet operations electrodes, and even more particularly wherein the droplet operations electrodes and the one or more counter-electrodes are spaced widely apart. In some embodiments, the first rail and the second rail each comprise a topmost surface, wherein there is a gap between the top substrate and the topmost surfaces of each of the first rail and the second rail. In other embodiments, there is no gap between the top substrate and the topmost surfaces of each of the first rail and the second rail.

In another embodiment, the droplet operations electrodes and the one or more counter-electrodes of the droplet actuator are substantially aligned opposite one another. In a further embodiment, the droplet operations electrodes and the one or more counter-electrodes are offset from one another. In yet another embodiment, the one or more counter-electrodes comprise a line of multiple ground reference electrodes. In another embodiment, the one or more counter-electrodes comprise a continuous ground reference electrode. In a further embodiment, along a length of the droplet operations channel, the one or more counter-electrodes alternate between placement atop the first rail and placement atop the second rail, and wherein along the length of the droplet operations channel the droplet operations electrodes alternate between placement atop the first rail and placement atop the second rail such that the droplet operations electrodes are opposite the one or more counter-electrodes. In yet another embodiment, the droplet operations channel is provided only in a heated region of the droplet actuator. In a further embodiment, the droplet operations channel is provided in both heated and regions of the droplet actuator. In another embodiment the droplet actuator further comprises one or more additional droplet operations channels. In a further embodiment, each of the droplet operations electrodes and the one or more counter-electrodes are configured to allow for switching between activation with an electrowetting voltage and providing an electrical ground.

The invention also provides a droplet actuator comprising: a) a top substrate and a bottom substrate separated to form a droplet operations gap; wherein the bottom substrate comprises a first rail and a second rail separated to form a droplet operations channel; b) droplet operations electrodes atop the bottom substrate; and c) one or more counter-electrodes atop a side of the first rail and atop a side of the second rail, wherein the sides of the first rail and second rail face the droplet operations channel; wherein the droplet operations electrodes are arranged to maintain contact between a droplet and the one or more counter-electrodes during droplet operations.

The invention also provides a droplet actuator comprising: a) a top substrate and a bottom substrate separated to form a droplet operations gap; wherein the bottom substrate comprises a first rail and a second rail separated to form a droplet operations channel; b) droplet operations electrodes atop a side of the first rail and atop a side of the second rail, wherein the sides of the first rail and second rail face the droplet operations channel; and c) counter-electrodes arranged within the droplet operations channel, wherein the counter-electrodes comprise pins arranged vertically between the bottom substrate and the top substrate; wherein the droplet operations electrodes are arranged to maintain contact between a droplet and the counter-electrodes during droplet operations. In some embodiments, the pins are offset from one another and are independently controlled. In other embodiments, the pins are substantially aligned with one another in a row and are independently controlled. In a further embodiment, each of the droplet operations electrodes and the one or more counter-electrodes are configured to allow for switching between activation with an electrowetting voltage and providing an electrical ground.

The invention also provides a method of reducing or eliminating the formation of bubbles in a droplet during droplet operations on a droplet actuator, comprising performing droplet operations on the droplet using any of the droplet actuators described herein. In some embodiments, the droplet operations comprise droplet splitting. In other embodiments, the droplet operations comprise droplet merging. In further embodiments, the droplet operations comprise transporting the droplet. In another embodiment, the droplet operations comprise droplet dispensing.

### DEFINITIONS

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used. For example, an electrode may be activated using a voltage which is greater than about 150 V, or greater than about 200 V, or greater than about 250 V, or from about 275 V to about 1000 V, or about 300 V. Where alternating current is used, any suitable frequency may be employed. For example, an electrode may be activated using alternating current having a frequency from about 1 Hz to about 10 MHz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a flow path that permits a droplet including the beads to be brought into a droplet operations gap or into contact with a droplet operations surface. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 20050260686, entitled “Multiplex flow assays preferably with magnetic particles as solid phase,” published on Nov. 24, 2005; 20030132538, entitled “Encapsulation of discrete quanta of fluorescent particles,” published on Jul. 17, 2003; 20050118574, entitled “Multiplexed Analysis of Clinical Specimens Apparatus and Method,” published on Jun. 2, 2005; 20050277197. Entitled “Microparticles with Multiple Fluorescent Signals and Methods of Using Same,” published on Dec. 15, 2005; 20060159962, entitled “Magnetic Microspheres for use in Fluorescence-based Applications,” published on Jul. 20, 2006; the entire disclosures of which are incorporated herein by reference for their teaching concerning beads and magnetically responsive materials and beads. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 20080305481, entitled “Systems and Methods for Multiplex Analysis of PCR in Real Time,” published on Dec. 11, 2008; U.S. Patent Publication No. 20080151240, “Methods and Systems for Dynamic Range Expansion,” published on Jun. 26, 2008; U.S. Patent Publication No. 20070207513, entitled “Methods, Products, and Kits for Identifying an Analyte in a Sample,” published on Sep. 6, 2007; U.S. Patent Publication No. 20070064990, entitled “Methods and Systems for Image Data Processing,” published on Mar. 22, 2007; U.S. Patent Publication No. 20060159962, entitled “Magnetic Microspheres for use in Fluorescence-based Applications,” published on Jul. 20, 2006; U.S. Patent Publication No. 20050277197, entitled “Microparticles with Multiple Fluorescent Signals and Methods of Using Same,” published on Dec. 15, 2005; and U.S. Patent Publication No. 20050118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass), PARYLENE™ N, and PARYLENE™ HT (for high temperature, ˜300° C.) (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; and polypropylene. Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1×-, 2×-3×-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity oil, such as silicone oil or hexadecane filler fluid. The filler fluid may be or include a halogenated oil, such as a fluorinated or perfluorinated oil. The filler fluid may fill the entire gap of the droplet actuator or may coat one or more surfaces of the droplet actuator. Filler fluids may be conductive or non-conductive. Filler fluids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200 C, viscosity=2.4 cSt, d=1.79), Galden HT230 (bp=230 C, viscosity=4.4 cSt, d=1.82) (all from Solvay Solexis); those in the Novec line, such as Novec 7500 (bp=128 C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler fluids is based on kinematic viscosity (<7 cSt is preferred, but not required), and on boiling point (>150° C. is preferred, but not required, for use in DNA/RNA-based applications (PCR, etc.)). Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe3O4, BaFe12O19, CoO, NiO, Mn2O3, Cr2O3, and CoMnP.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Transporting into the magnetic field of a magnet,” “transporting towards a magnet,” and the like, as used herein to refer to droplets and/or magnetically responsive beads within droplets, is intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, is intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of” or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### DESCRIPTION

The present invention is directed to methods of providing reliable electrical connections to droplets in a droplet actuator and, in so doing, reduce or eliminate gas bubble formation in the droplet actuator.

In some embodiments, droplet actuators are provided that include a droplet operations channel, wherein the sidewalls of the droplet operations channel have electrodes arranged therein to assist the droplet to be in reliable contact with the ground reference of the droplet actuator.

In another embodiment, droplet actuators are provided that include droplet operations channels for processing small droplets, such as sub-micron droplets.

In yet another embodiment, droplet actuators are provided that include an array of independently controlled electrode pins to perform various droplet operations, such as, but not limited to, droplet splitting, merging, transporting, and dispensing operations. The array of independently controlled electrode pins facilitates reliable contact with the ground reference of the droplet actuator.

While herein described are various techniques to assist the droplet to be in reliable contact with the ground reference electrode of the droplet actuator, which is one example of the counter-electrode of the droplet operations electrodes, the invention is not limited to ground electrodes only. The invention is suitable for assisting the droplet to be in reliable contact between any types of electrical contacts within the droplet actuator, such as ground, fixed voltages, oscillating voltages, floating nodes, and the like. As such, ground reference electrode or ground electrode can mean any type of electrical contact that is the counter-electrode of the droplet operations electrodes.

### 7.1 Droplet Operations Channels

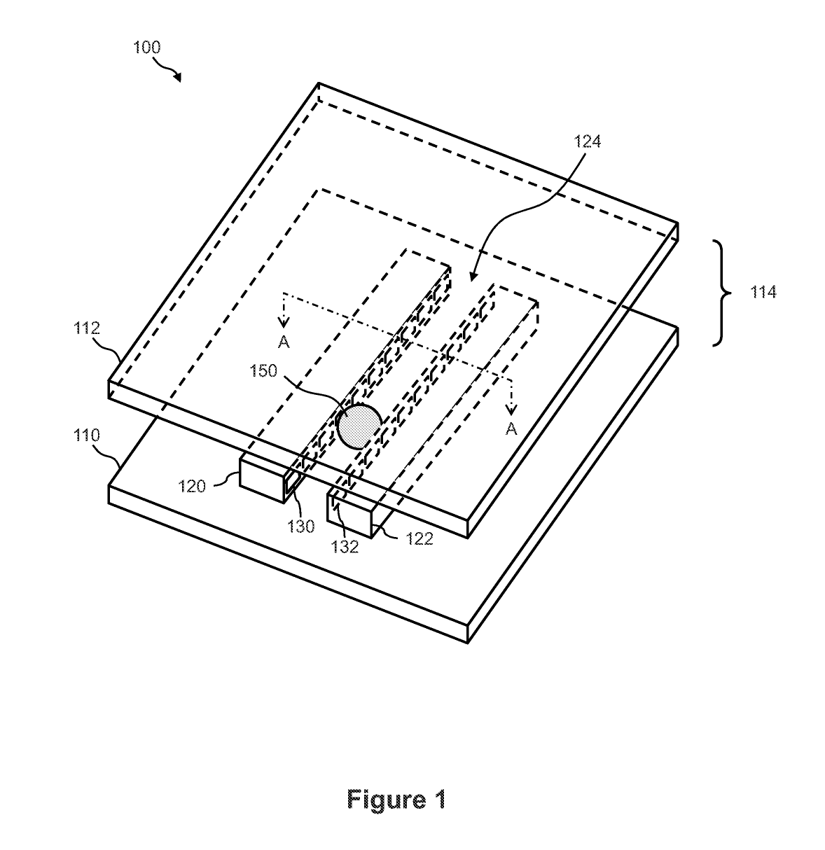

FIG. 1 illustrates an isometric view of a droplet actuator 100 that includes a droplet operations channel, wherein the sidewalls of the droplet operations channel include electrode arrangements to assist the droplet to be in reliable contact with the ground reference of the droplet actuator. Droplet actuator 100 includes a bottom substrate 110 and a top substrate 112 that are separated by a gap 114.

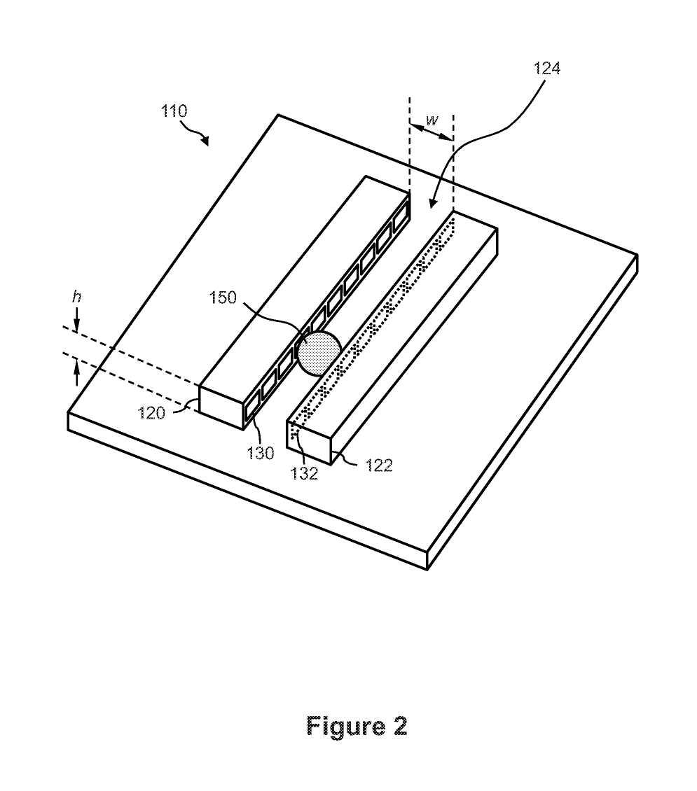

Referring now to FIG. 2, which is an isometric view of bottom substrate 110 alone, bottom substrate 110 further includes a first rail 120 and a second rail 122. First rail 120 and second rail 122 are elongated three-dimensional (3D) structures that are arranged in parallel with each other. There is a space between first rail 120 and second rail 122. The space between first rail 120 and second rail 122 forms a droplet operations channel 124. More particularly, the side of first rail 120 that is facing droplet operations channel 124 and the side of second rail 122 that is facing droplet operations channel 124 provide droplet operations surfaces. First rail 120 and second rail 122 have a certain height and spacing. As a result, droplet operations channel 124 has a height h that corresponds to the height of first rail 120 and second rail 122 and a width w that corresponds to the space between first rail 120 and second rail 122.

Accordingly, an arrangement of droplet operations electrodes 130 are provided on the surface of first rail 120 that is facing droplet operations channel 124. Similarly, an arrangement of ground reference electrodes 132 are provided on the surface of second rail 122 that is facing droplet operations channel 124. As a result, droplet operations can be conducted along droplet operations channel 124 using droplet operations electrodes 130 and ground reference electrodes 132. The width w and the height h of droplet operations channel 124 are set such that a droplet (e.g., droplet 150) of a certain volume may be manipulated along droplet operations channel 124. Using droplet operations electrodes 130 and ground reference electrodes 132, a droplet, such as a droplet 150, can be transported along the droplet operations channel 124.

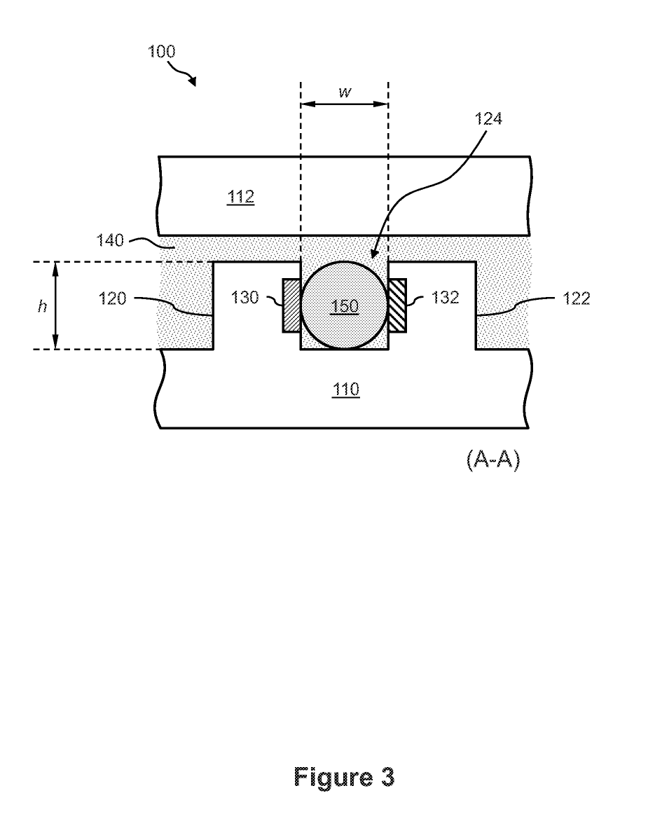

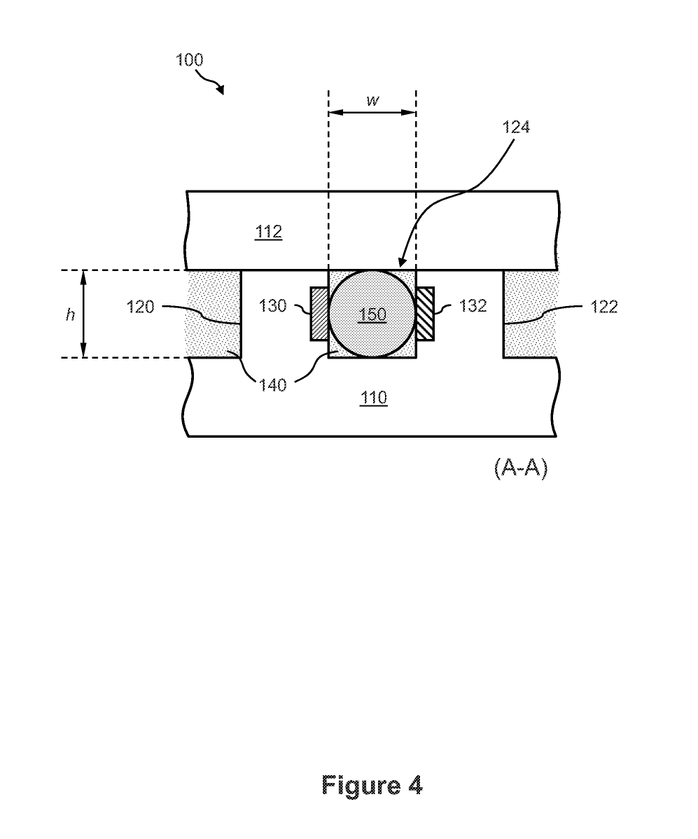

Referring now to FIG. 3, which is a cross-sectional view of a portion of droplet actuator 100 taken along line A-A of FIG. 1, there is a gap between top substrate 112 and the topmost surfaces of first rail 120 and second rail 122 that allows the full volume between bottom substrate 110 and top substrate 112 to be filled with filler fluid 140. However, in another example, and referring now to FIG. 4, there is no gap between top substrate 112 and the topmost surfaces of first rail 120 and second rail 122. In this example, top substrate 112 sits substantially atop the topmost surfaces of first rail 120 and second rail 122.

In operation and referring to FIGS. 1, 2, 3, and 4, because droplet operations are conducted between droplet operations electrodes 130 and ground reference electrodes 132, which are arranged on the sidewalls of first rail 120 and second rail 122, respectively, gravity does not come into play (as shown in FIG. 2) to cause droplet 150 to lose contact with ground during any phase of the droplet operations. In this way, reliable contact between droplet 150 and, for example, ground reference electrodes 132 is maintained, thus reducing or eliminating the formation of bubbles.

Droplet actuator 100 and more particularly droplet operations channel 124 is not limited to the electrode arrangements shown in FIGS. 1, 2, and 3. Other electrode arrangements may be used in droplet operations channel 124, examples of which are described below with reference to FIGS. 4 through 22B.

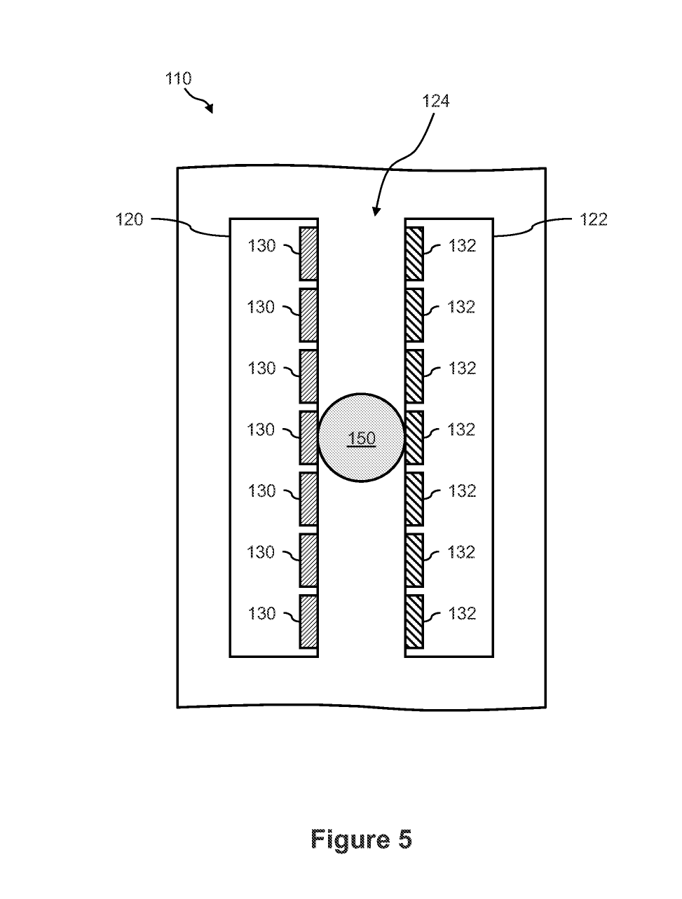

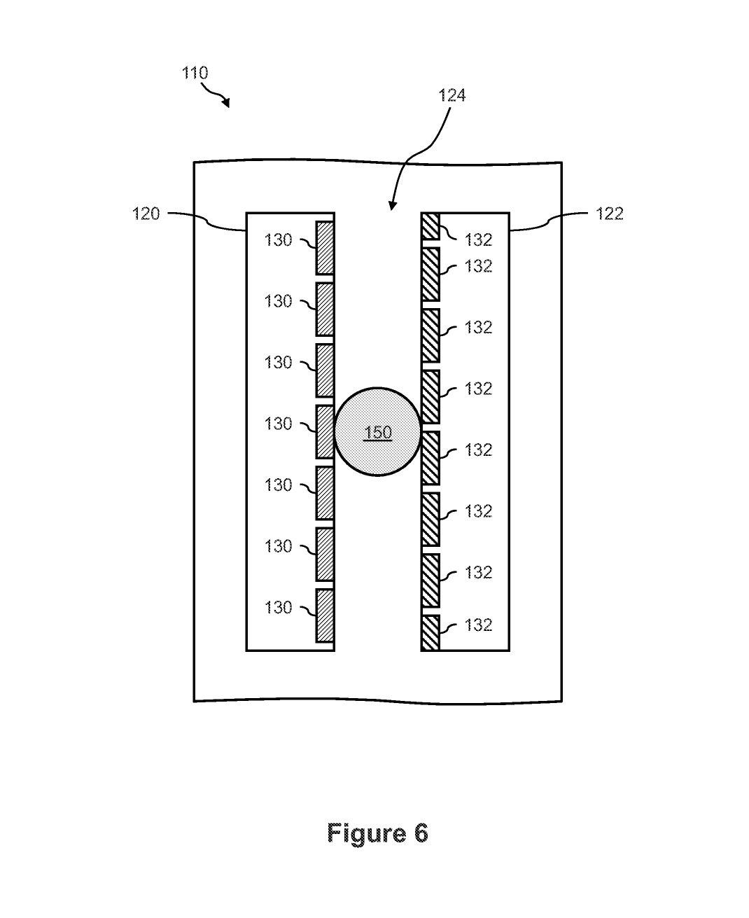

Droplet operations electrodes 130 and ground reference electrodes 132 can be provided in various configurations. For example, FIG. 5 illustrates a plan view of a portion of bottom substrate 110 in which droplet operations electrodes 130 and ground reference electrodes 132 are substantially aligned opposite one another. However, in another example, FIG. 6 illustrates a plan view of a portion of bottom substrate 110 in which droplet operations electrodes 130 and ground reference electrodes 132 are staggered or offset from one another.

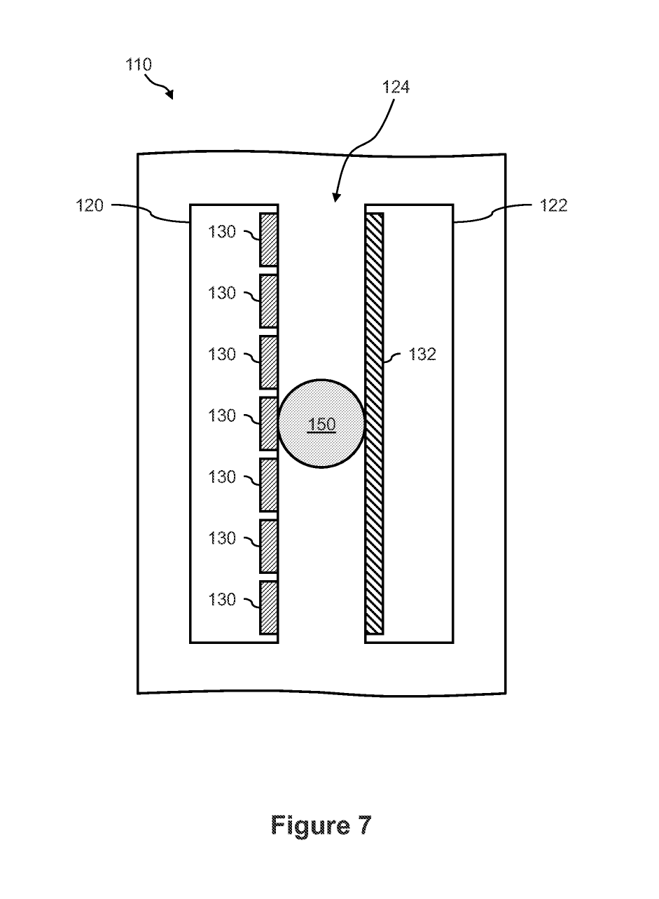

In yet another example, FIG. 7 illustrates a plan view of a portion of bottom substrate 110 in which the line of multiple ground reference electrodes 132 is replaced with a continuous ground reference electrode 132.

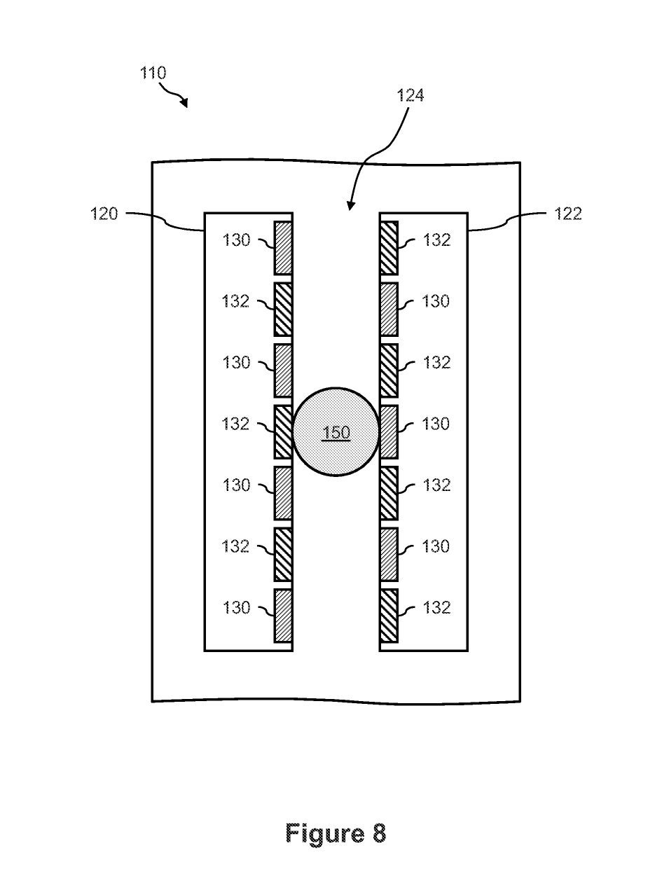

In yet another example, FIG. 8 illustrates a plan view of a portion of bottom substrate 110 in which droplet operations electrodes 130 and ground reference electrodes 132 are alternating along both first rail 120 and second rail 122. Additionally, in this arrangement, each droplet operations electrode 130 on one sidewall is opposite a ground reference electrode 132 on the opposite sidewall.

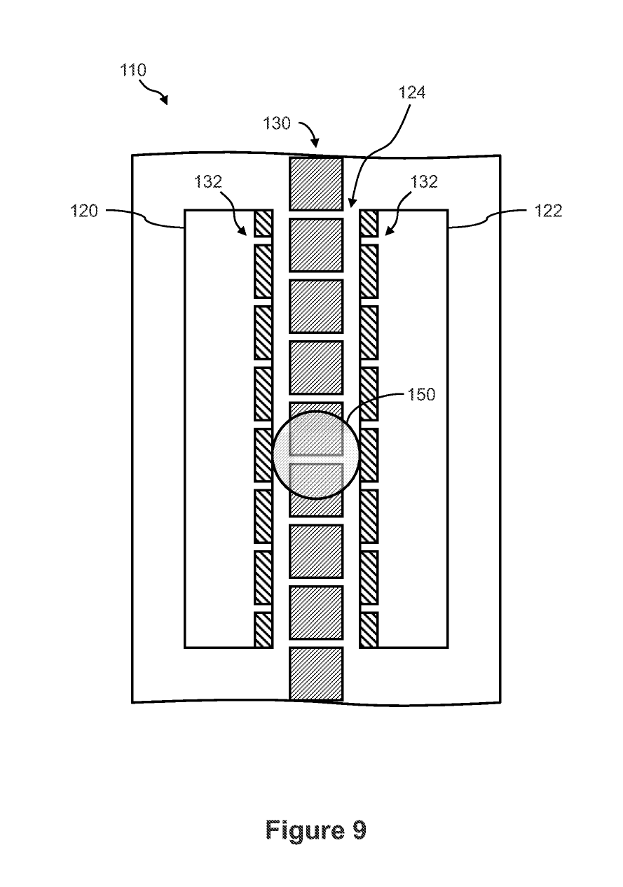

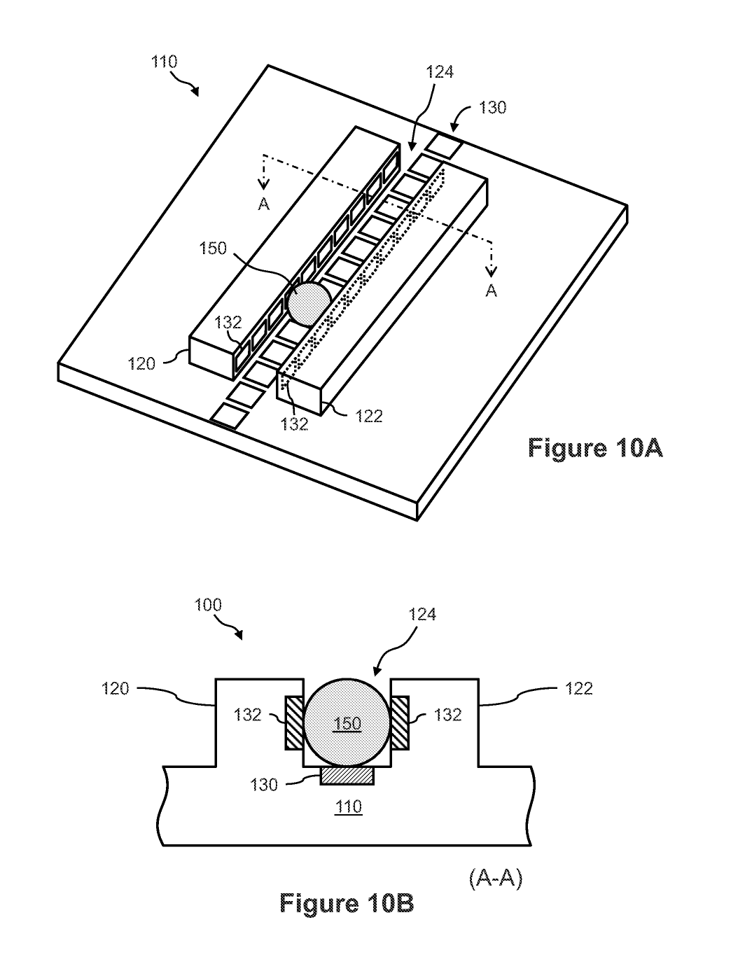

In yet another example, FIG. 9 illustrates a plan view of a portion of bottom substrate 110 in which ground reference electrodes 132 (or a continuous ground reference electrode 132) are provided along both first rail 120 and second rail 122 and the droplet operations electrodes 130 are provided on the floor of droplet operations channel 124. For example, FIG. 10A illustrates an isometric view of the bottom substrate 110 shown in FIG. 9 and FIG. 10B illustrates a cross-sectional view of a portion of bottom substrate 110 taken along line A-A of FIG. 10A. Again, FIGS. 10A and 10B show droplet operations electrodes 130 arranged on the floor of droplet operations channel 124 instead of on the sidewalls of droplet operations channel 124.

Referring again to FIGS. 1 through 10B, in one embodiment, one or more droplet operations channels 124 are provided in heated regions only of a droplet actuator and used to maintain reliable contact of droplets to ground, thus reducing or eliminating the formation of bubbles. In another embodiment, one or more droplet operations channels 124 are provided in both heated regions and unheated regions of a droplet actuator.

### 7.2 Droplet Operations Channels for Processing Small Droplets

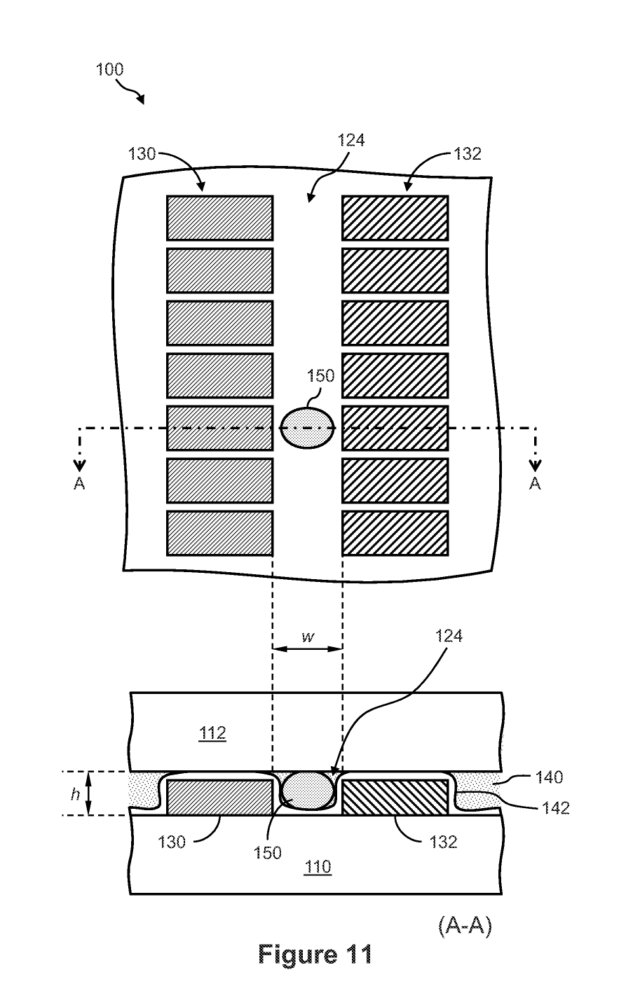

FIG. 11 illustrates a plan view and a cross-sectional view of droplet actuator 100 and showing another method of implementing droplet operations channel 124 for processing small droplets, such as sub-micron droplets. In this example, a line of droplet operations electrodes 130 and a line of ground reference electrodes 132 are patterned atop the bottom substrate 110. A hydrophobic coating 142 may be provided atop droplet operations electrodes 130 and ground reference electrodes 132. The droplet operations channel 124 is formed in the space between the line of droplet operations electrodes 130 and line of ground reference electrodes 132. Further, the top substrate 112 sits atop the droplet operations electrodes 130 and the ground reference electrodes 132. Accordingly, the height h of the droplet operations channel 124 is set by the height of the droplet operations electrodes 130 and ground reference electrodes 132. Further, the width w of the droplet operations channel 124 is set by the space between the line of droplet operations electrodes 130 and line of ground reference electrodes 132.

Like the droplet operations channel 124 described in FIGS. 1 through 10B, in the droplet operations channel 124 of FIG. 11 the droplet operations electrodes 130 and ground reference electrodes 132 can be aligned, staggered or offset, alternating, and the like.

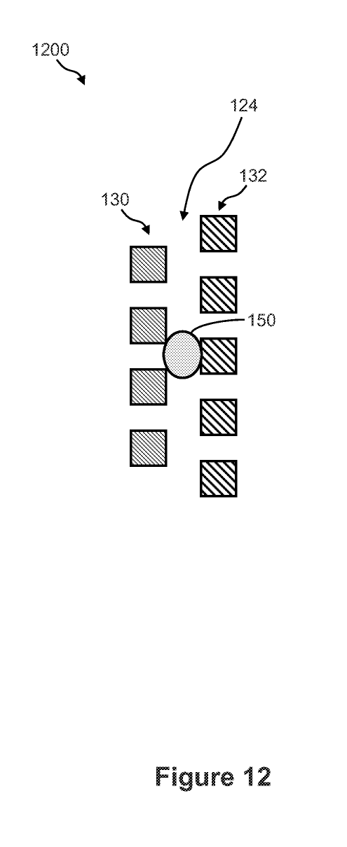

In the example shown in FIG. 11, fine features are not needed to affect small gaps between electrodes of a droplet actuator, such as droplet actuator 100. For example, when forming the bottom substrate 110, which is, for example, a printed circuit board (PCB), fine features are not needed to affect small gaps between electrodes. Namely, the electrodes can be spaced out, which allows relaxed manufacturing specifications and fewer electrodes per square inch of the PCB. This enables small droplets (e.g., sub-micron droplets) to be processed in a droplet actuator. More examples of electrode arrangements for processing small droplets using the configuration shown in FIG. 11 are shown and described below with reference to FIGS. 12 through 16B.

FIG. 12 illustrates a plan view of an electrode arrangement 1200 in which droplet operations electrodes 130 and ground reference electrodes 132 are staggered or offset from one another along, for example, droplet operations channel 124. A main aspect of electrode arrangement 1200 is that droplet operations electrodes 130 and ground reference electrodes 132 are spaced widely apart; again, allowing relaxed manufacturing specifications.

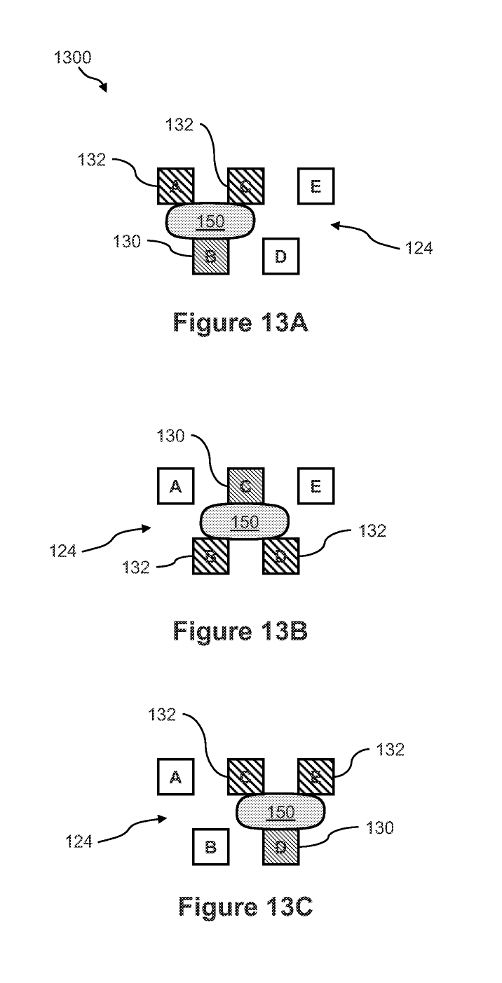

FIGS. 13A, 13B, and 13C illustrate plan views of an electrode arrangement 1300 in which the electrodes along the droplet operations channel 124 can be dynamically switched between an electrowetting voltage and electrical ground. In this example, electrode arrangement 1300 includes electrodes A, B, C, D, and E that are arranged as shown, whereas each of the electrodes A, B, C, D, and E can be independently switched between an electrowetting voltage and electrical ground. In other words, at any given time, each of the electrodes A, B, C, D, and E in electrode arrangement 1300 can be either a droplet operations electrode 130 or a ground reference electrode 132.

By way of example, FIGS. 13A, 13B, and 13C show an electrode sequence and process of transporting droplet 150 along electrode arrangement 1300. In a first step and referring to FIG. 13A, electrodes A and C are set to ground reference electrodes 132 and electrode B is set to a droplet operations electrode 130. Accordingly, droplet 150 sits at electrode B. In a next step and referring to FIG. 13B, electrodes B and D are set to ground reference electrodes 132 and electrode C is set to a droplet operations electrode 130. Accordingly, droplet 150 moves along electrode arrangement 1300 and now sits at electrode C. In a next step and referring to FIG. 13C, electrodes C and E are set to ground reference electrodes 132 and electrode D is set to a droplet operations electrode 130. Accordingly, droplet 150 moves along electrode arrangement 1300 and now sits at electrode D. In this process, using droplet operations, droplet 150 has been transported from electrode B to electrode D of electrode arrangement 1300.

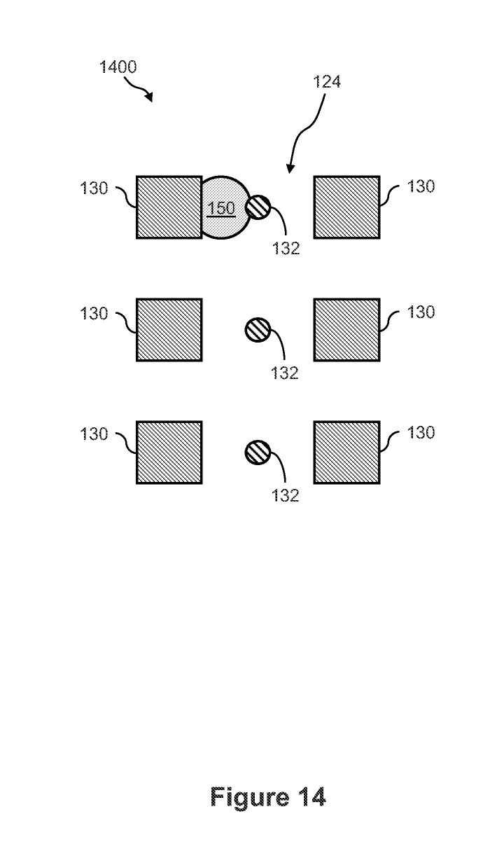

FIG. 14 illustrates a plan view of an electrode arrangement 1400 in which droplet operations electrodes 130 are arranged on each side of the droplet operations channel 124 and a set of ground reference electrodes 132 are arranged within the droplet operations channel 124, wherein ground reference electrodes 132 are provided, for example, in the form of ground pins. Namely, the ground reference electrodes 132 are ground pins that are installed vertically between bottom substrate 110 (not shown) and top substrate 112 (not shown). In this example, the ground pins are in the droplet operations channel 124 and between two lines of droplet operations electrodes 130.

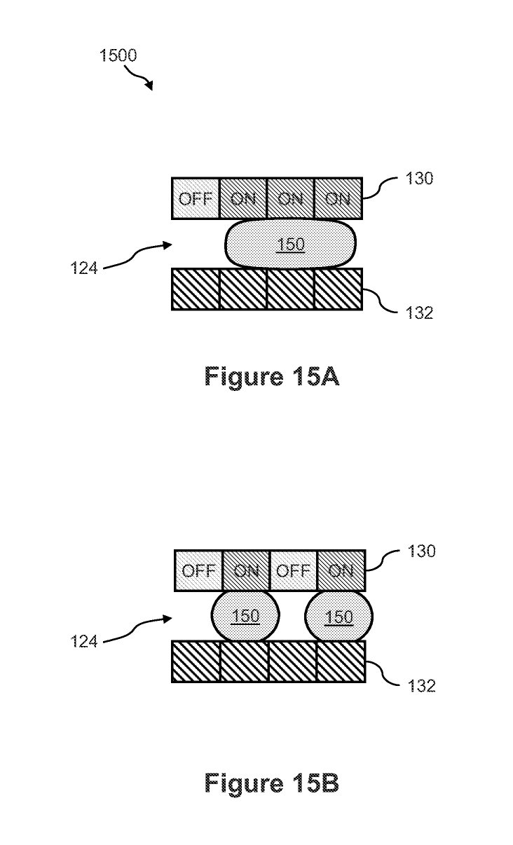

FIGS. 15A and 15B illustrate plan views an electrode arrangement 1500 that includes droplet operations channel 124 in which droplet splitting operations can occur via droplet operations. Namely, FIGS. 15A and 15B show a line of droplet operations electrodes 130 on one side of droplet operations channel 124 and a line of ground reference electrodes 132 on the other side of droplet operations channel 124. In a first step and referring to FIG. 15A, three droplet operations electrodes 130 in a row are activated. As a result, droplet 150 is stretched in a slug of liquid across the three droplet operations electrodes 130. In a next step and referring to FIG. 15B, the second of the three droplet operations electrodes 130 is deactivated. As a result, the slug of liquid splits into two droplets 150, which are atop the two droplet operations electrodes 130 that are activated.

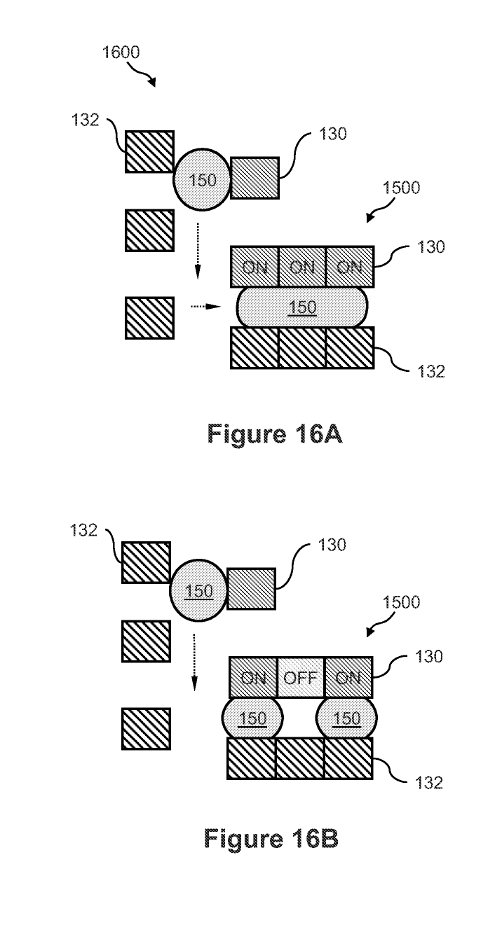

Electrode arrangement 1500 can be a droplet splitter module that is integrated into a larger electrode arrangement in a droplet actuator. For example, FIGS. 16A and 16B illustrate a plan view of an electrode arrangement 1600 in which electrodes are arranged to facilitate the movement of droplet 150 into a droplet splitting region, which is electrode arrangement 1500. For example, electrode arrangement 1600 includes various other droplet operations electrodes 130 and ground reference electrodes 132 for feeding droplets into the droplet splitting region, which is electrode arrangement 1500. FIGS. 16A and 16B show the droplet splitting operation as described with reference to FIGS. 15A and 15B.

### 7.3 Electrode Pins for Processing Droplets

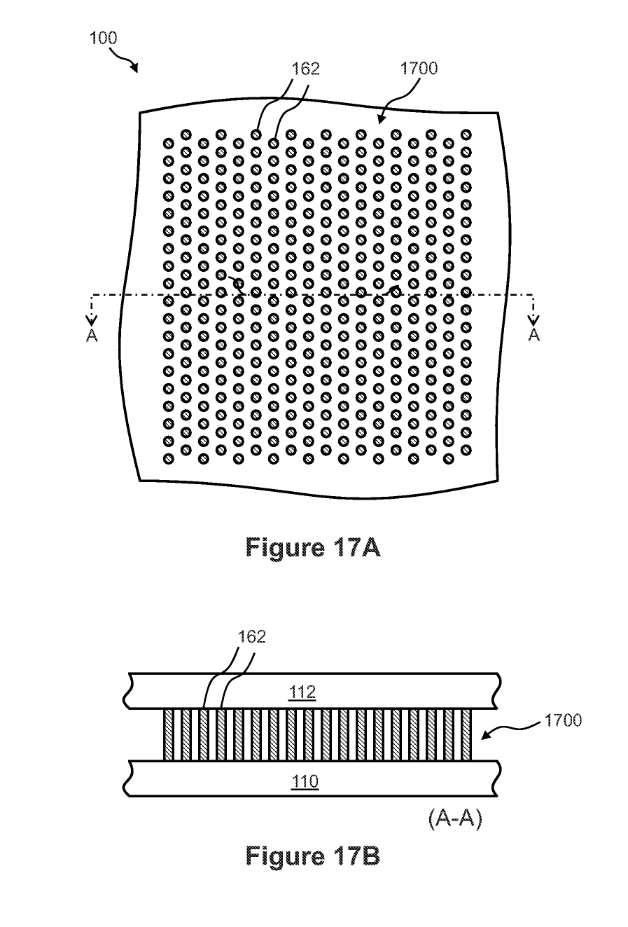

FIGS. 17A and 17B illustrate a plan view and a cross-sectional view, respectively, of a portion of droplet actuator 100 that includes an electrode arrangement 1700. The cross-sectional view of FIG. 17B is taken along line A-A of FIG. 17A. For example, electrode arrangement 1700 includes an array of electrode pins 162, wherein the electrode pins 162 are installed vertically between bottom substrate 110 and top substrate 112. The array of independently controlled electrode pins 162 assists the droplet to be in reliable contact with the ground reference of the droplet actuator.

In the example shown in FIG. 17A, the rows and/or columns of electrode pins 162 are staggered or offset. However, in another example, the electrode pins 162 are substantially aligned from row to row and/or from column to column.

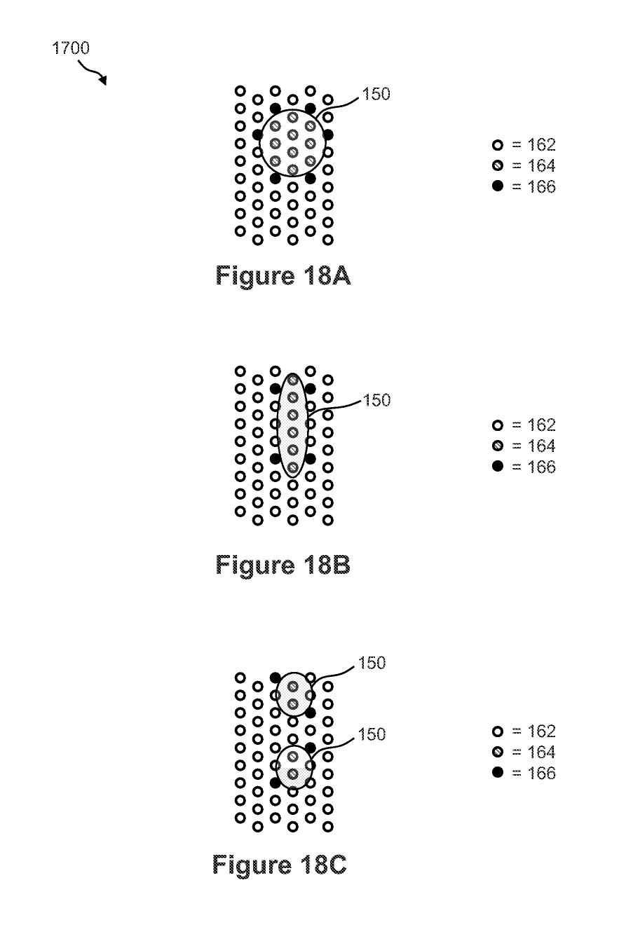

Additionally, certain electrode pins 162 of electrode arrangement 1700 may be electrically connected to an electrowetting voltage, thereby providing droplet operations pins. Certain other electrode pins 162 of electrode arrangement 1700 may be electrically connected to ground, thereby providing ground reference pins. In one example, the arrangement of droplet operations pins and ground reference pins is fixed. In another example, the arrangement of droplet operations pins and ground reference pins is programmable. Namely, each of the electrode pins 162 (or groups of electrode pins 162) can be switched dynamically between an electrowetting voltage and ground and controlled independently. Examples of using independently controlled electrode pins 162 to perform various droplet operations are described below with reference to FIGS. 18A through 22C. In FIGS. 18A through 22C, an electrode pin 162 that is connected to an electrowetting voltage is called a droplet operations pin 164 and an electrode pin 162 that is connected to ground is called a ground reference pin 166.

FIGS. 18A, 18B, and 18C show a portion of electrode arrangement 1700 and a process of performing a droplet splitting operation. In a first step, FIG. 18A shows a droplet 150 that is retained via a certain pattern of droplet operations pins 164 and ground reference pins 166. In a next step and referring to FIG. 18B, a different pattern of droplet operations pins 164 and ground reference pins 166 is activated, which causes the droplet 150 shown in FIG. 18A to become elongated, as shown in FIG. 18B. In a next step and referring to FIG. 18C, yet a different pattern of droplet operations pins 164 and ground reference pins 166 is activated, which causes the elongated droplet 150 shown in FIG. 18B to split, thereby forming two smaller droplets 150 as compared with the original single droplet 150 of FIG. 18A.

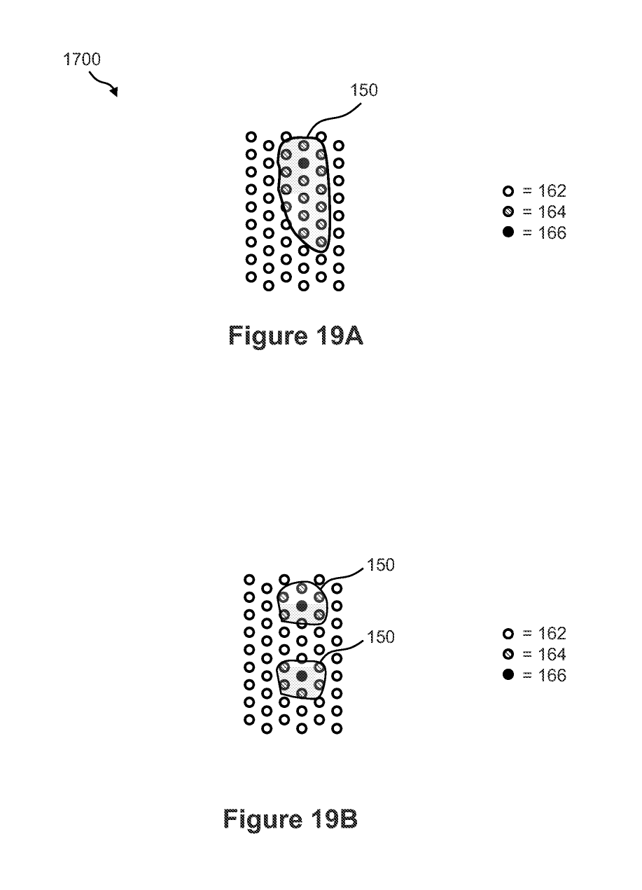

FIGS. 19A and 19B show a portion of electrode arrangement 1700 and another process of performing a droplet splitting operation. In a first step, FIG. 19A shows a droplet 150 that is retained via a certain pattern of droplet operations pins 164 and ground reference pins 166. In a next step and referring to FIG. 19B, a different pattern of droplet operations pins 164 and ground reference pins 166 is activated, which causes the droplet 150 shown in FIG. 19A to split, thereby forming two smaller droplets 150 as compared with the original single droplet 150 of FIG. 19A.

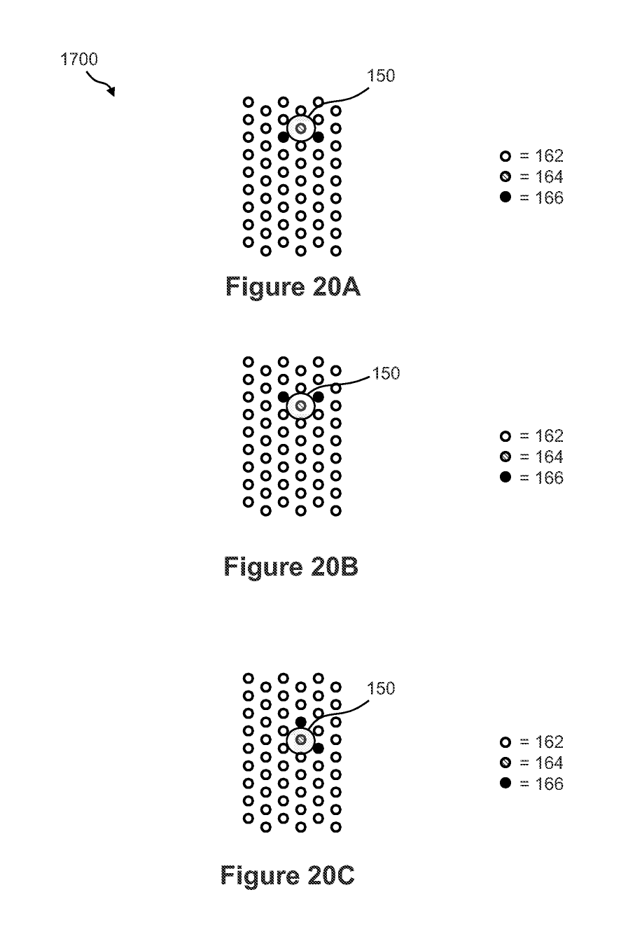

FIGS. 20A, 20B, and 20C show a portion of electrode arrangement 1700 and a process of performing a droplet transport operation. In a first step, FIG. 20A shows a droplet 150 that is retained via a certain pattern of droplet operations pins 164 and ground reference pins 166. In a next step and referring to FIG. 20B, a different pattern of droplet operations pins 164 and ground reference pins 166 is activated, which causes the droplet 150 shown in FIG. 20A to move to the next droplet operations pin 164 in the line, as shown in FIG. 20B. In a next step and referring to FIG. 20C, yet a different pattern of droplet operations pins 164 and ground reference pins 166 is activated, which causes the droplet 150 shown in FIG. 20B to move to the next droplet operations pin 164 in the line, as shown in FIG. 20C.

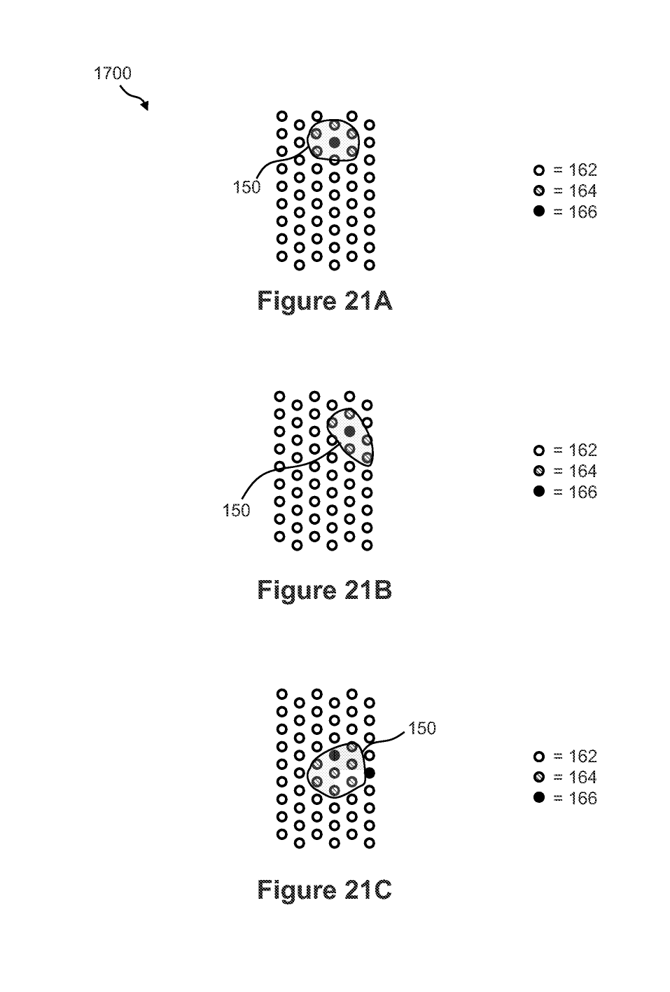

FIGS. 21A, 21B, and 21C show a portion of electrode arrangement 1700 and another process of performing a droplet transport operation. In a first step, FIG. 21A shows a droplet 150 that is retained via a certain pattern of droplet operations pins 164 and ground reference pins 166. Namely, droplet 150 is retained at a certain group of droplet operations pins 164. In a next step and referring to FIG. 21B, a different pattern of droplet operations pins 164 and ground reference pins 166 is activated, which causes the droplet 150 shown in FIG. 21A to move to another group of droplet operations pin 164, as shown in FIG. 21B. In a next step and referring to FIG. 21C, yet a different pattern of droplet operations pins 164 and ground reference pins 166 is activated, which causes the droplet 150 shown in FIG. 21B to move to another group of droplet operations pin 164, as shown in FIG. 21C.

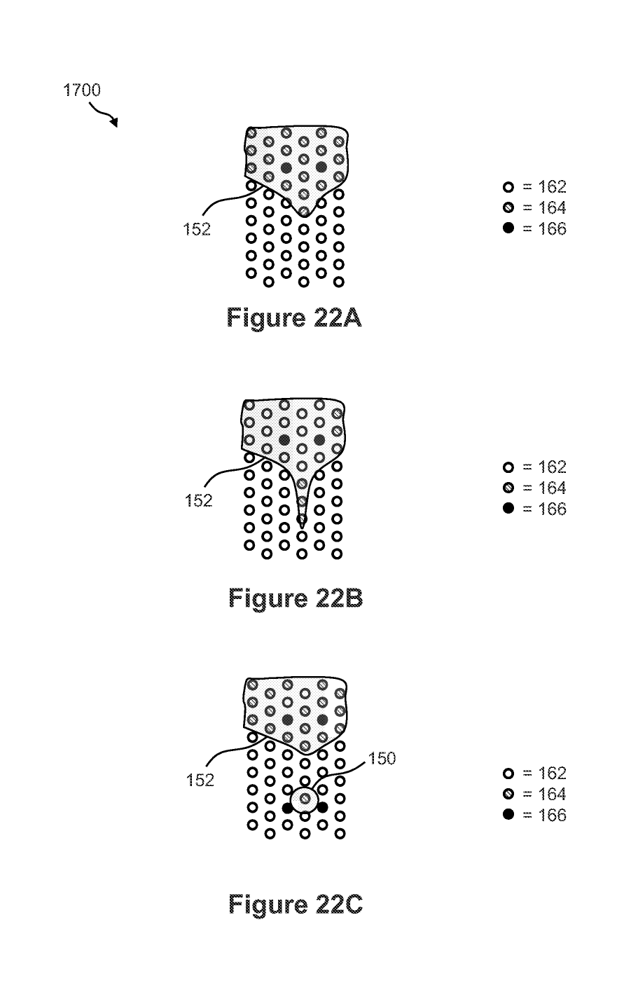

FIGS. 22A, 22B, and 22C show a portion of electrode arrangement 1700 and a process of performing a droplet dispensing operation. In this example, electrode arrangement 1700 may be associated with an on-actuator fluid reservoir. In a first step, FIG. 22A shows a volume of fluid 152 that is retained via a certain pattern of droplet operations pins 164 and ground reference pins 166. In a next step and referring to FIG. 22B, a different pattern of droplet operations pins 164 and ground reference pins 166 is activated, which causes an elongated slug of fluid 152 to form along a line of droplet operations pins 164. In a next step and referring to FIG. 22C, yet a different pattern of droplet operations pins 164 and ground reference pins 166 is activated, which causes the elongated slug of fluid 152 shown in FIG. 22B to split off from the main volume of fluid 152, thereby dispensing a small droplet 150.

Referring again to FIGS. 17A through 22C, in electrode arrangement 1700, the ground reference pins 166 can be inside and/or outside of the volume of liquid or droplet as long as the volume of liquid or droplet is in contact with the ground reference pins 166.

### 7.4 Systems

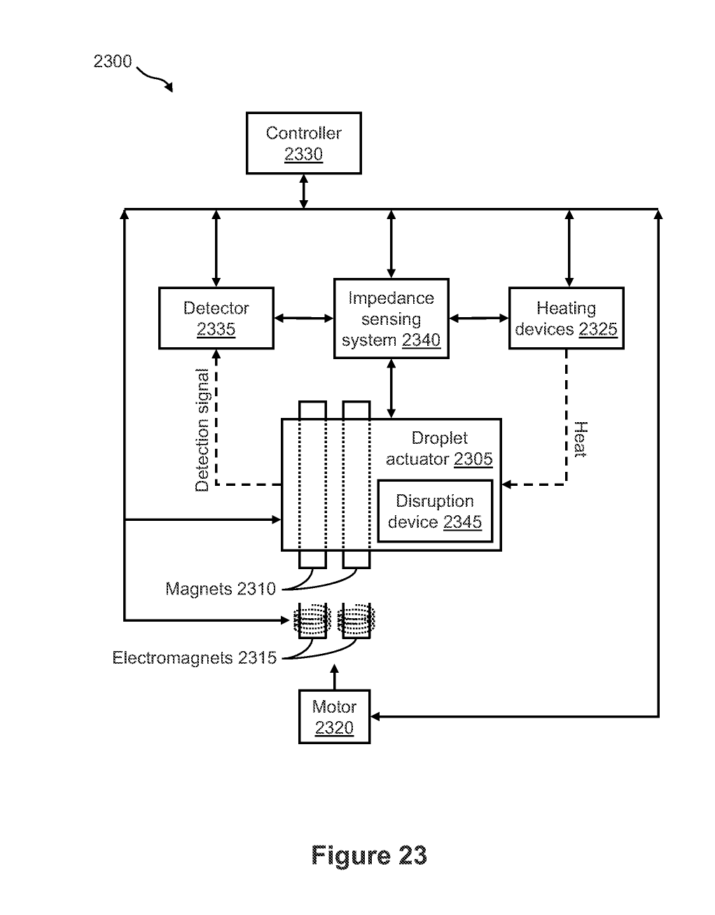

FIG. 23 illustrates a functional block diagram of an example of a microfluidics system 2300 that includes a droplet actuator 2305. Digital microfluidic technology conducts droplet operations on discrete droplets in a droplet actuator, such as droplet actuator 2305, by electrical control of their surface tension (electrowetting). The droplets may be sandwiched between two substrates of droplet actuator 2305, a bottom substrate and a top substrate separated by a droplet operations gap. The bottom substrate may include an arrangement of electrically addressable electrodes. The top substrate may include a reference electrode plane made, for example, from conductive ink or indium tin oxide (ITO). The bottom substrate and the top substrate may be coated with a hydrophobic material. Droplet operations are conducted in the droplet operations gap. The space around the droplets (i.e., the gap between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Droplet actuator 2305 may be designed to fit onto an instrument deck (not shown) of microfluidics system 2300. The instrument deck may hold droplet actuator 2305 and house other droplet actuator features, such as, but not limited to, one or more magnets and one or more heating devices. For example, the instrument deck may house one or more magnets 2310, which may be permanent magnets. Optionally, the instrument deck may house one or more electromagnets 2315. Magnets 2310 and/or electromagnets 2315 are positioned in relation to droplet actuator 2305 for immobilization of magnetically responsive beads. Optionally, the positions of magnets 2310 and/or electromagnets 2315 may be controlled by a motor 2320. Additionally, the instrument deck may house one or more heating devices 2325 for controlling the temperature within, for example, certain reaction and/or washing zones of droplet actuator 2305. In one example, heating devices 2325 may be heater bars that are positioned in relation to droplet actuator 2305 for providing thermal control thereof.

A controller 2330 of microfluidics system 2300 is electrically coupled to various hardware components of the invention, such as droplet actuator 2305, electromagnets 2315, motor 2320, and heating devices 2325, as well as to a detector 2335, an impedance sensing system 2340, and any other input and/or output devices (not shown). Controller 2330 controls the overall operation of microfluidics system 2300. Controller 2330 may, for example, be a general purpose computer, special purpose computer, personal computer, or other programmable data processing apparatus. Controller 2330 serves to provide processing capabilities, such as storing, interpreting, and/or executing software instructions, as well as controlling the overall operation of the system. Controller 2330 may be configured and programmed to control data and/or power aspects of these devices. For example, in one aspect, with respect to droplet actuator 2305, controller 2330 controls droplet manipulation by activating/deactivating electrodes.

Detector 2335 may be an imaging system that is positioned in relation to droplet actuator 2305. In one example, the imaging system may include one or more light-emitting diodes (LEDs) (i.e., an illumination source) and a digital image capture device, such as a charge-coupled device (CCD) camera.

Impedance sensing system 2340 may be any circuitry for detecting impedance at a specific electrode of droplet actuator 2305. In one example, impedance sensing system 2340 may be an impedance spectrometer. Impedance sensing system 2340 may be used to monitor the capacitive loading of any electrode, such as any droplet operations electrode, with or without a droplet thereon. For examples of suitable capacitance detection techniques, see Sturmer et al., International Patent Publication No. WO/2008/101194, entitled “Capacitance Detection in a Droplet Actuator,” published on Aug. 21, 2008; and Kale et al., International Patent Publication No. WO/2002/080822, entitled “System and Method for Dispensing Liquids,” published on Oct. 17, 2002; the entire disclosures of which are incorporated herein by reference.

Droplet actuator 2305 may include disruption device 2345. Disruption device 2345 may include any device that promotes disruption (lysis) of materials, such as tissues, cells and spores in a droplet actuator. Disruption device 2345 may, for example, be a sonication mechanism, a heating mechanism, a mechanical shearing mechanism, a bead beating mechanism, physical features incorporated into the droplet actuator 2305, an electric field generating mechanism, a thermal cycling mechanism, and any combinations thereof. Disruption device 2345 may be controlled by controller 2330.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module,” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

### CONCLUDING REMARKS

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

1. A droplet actuator comprising:
a. a top substrate and a bottom substrate separated to form a droplet operations gap, wherein the bottom substrate comprises a first rail and a second rail separated to form a droplet operations channel;
b. droplet operations electrodes atop a side of the first rail, wherein the side of the first rail faces the droplet operations channel;
c. one or more counter-electrodes atop a side of the second rail, wherein the side of the second rail faces the droplet operations channel; and
wherein the droplet operations electrodes are arranged to maintain contact between a droplet and the one or more counter-electrodes during droplet operations.

2. The droplet actuator of claim 1, wherein the droplet operations electrodes comprise an array of independently controlled electrode pins.

3. The droplet actuator of claim 1, wherein the one or more counter-electrodes comprise ground electrodes.

4. The droplet actuator of claim 1, wherein the first rail and the second rail are each elongated three-dimensional (3D) structures.

5. The droplet actuator of claim 1, wherein the side of the first rail and the side of second rail each provide a droplet operations surface.

6. The droplet actuator of claim 1, wherein the droplet operations channel, the first rail, and the second rail each have a height h, and wherein the droplet operations channel has a width w.

7. The droplet actuator of claim 6, wherein height h and width w are set according to the volume of the droplet such that contact is maintained between the droplet and the one or more counter-electrodes during droplet operations.

8. The droplet actuator of claim 7, wherein the droplet is a sub-micron sized droplet.

9. The droplet actuator of claim 7, wherein a hydrophobic coating is provided atop the one or more counter-electrodes and the droplet operations electrodes.

10. The droplet actuator of claim 7, wherein the droplet operations electrodes and the one or more counter-electrodes are spaced widely apart.

11. The droplet actuator of claim 1, wherein the first rail and the second rail each comprise a topmost surface, and wherein there is a gap between the top substrate and the topmost surfaces of each of the first rail and the second rail.

12. The droplet actuator of claim 1, wherein the first rail and the second rail each comprise a topmost surface, and wherein there is no gap between the top substrate and the topmost surfaces of each of the first rail and the second rail.

13. The droplet actuator of claim 1, wherein the droplet operations electrodes and the one or more counter-electrodes are substantially aligned opposite one another.

14. The droplet actuator of claim 1, wherein the droplet operations electrodes and the one or more counter-electrodes are offset from one another.

15. The droplet actuator of claim 1, wherein the one or more counter-electrodes comprise a line of multiple ground reference electrodes.

16. The droplet actuator of claim 1, wherein the one or more counter-electrodes comprise a continuous ground reference electrode.

17. The droplet actuator of claim 1, wherein along a length of the droplet operations channel, the one or more counter-electrodes alternate between placement atop the first rail and placement atop the second rail, and wherein along the length of the droplet operations channel the droplet operations electrodes alternate between placement atop the first rail and placement atop the second rail such that the droplet operations electrodes are opposite the one or more counter-electrodes.

18. The droplet actuator of claim 1, wherein the droplet operations channel is provided only in a heated region of the droplet actuator.

19. The droplet actuator of claim 1, wherein the droplet operations channel is provided in both heated and regions of the droplet actuator.

20. The droplet actuator of claim 1, further comprising one or more additional droplet operations channels.

21. The droplet actuator of claim 15, wherein each of the droplet operations electrodes and the one or more counter-electrodes are configured to allow for switching between activation with an electrowetting voltage and providing an electrical ground.

22. A droplet actuator comprising:
a. a top substrate and a bottom substrate separated to form a droplet operations gap, wherein the bottom substrate comprises a first rail and a second rail separated to form a droplet operations channel;
b. droplet operations electrodes atop the bottom substrate;
c. one or more counter-electrodes atop a side of the first rail and atop a side of the second rail, wherein the sides of the first rail and second rail face the droplet operations channel; and
wherein the droplet operations electrodes are arranged to maintain contact between a droplet and the one or more counter-electrodes during droplet operations.

23. A droplet actuator comprising:
a. a top substrate and a bottom substrate separated to form a droplet operations gap, wherein the bottom substrate comprises a first rail and a second rail separated to form a droplet operations channel;
b. droplet operations electrodes atop a side of the first rail and atop a side of the second rail, wherein the sides of the first rail and second rail face the droplet operations channel;
c. counter-electrodes arranged within the droplet operations channel, wherein the counter-electrodes comprise pins arranged vertically between the bottom substrate and the top substrate; and
wherein the droplet operations electrodes are arranged to maintain contact between a droplet and the counter-electrodes during droplet operations.

24. The droplet actuator of claim 23, wherein the pins are offset from one another and are independently controlled.

25. The droplet actuator of claim 23, wherein the pins are substantially aligned with one another in a row and are independently controlled.

26. The droplet actuator of claim 23, wherein each of the droplet operations electrodes and the one or more counter-electrodes are configured to allow for switching between activation with an electrowetting voltage and providing an electrical ground.

27. A method of reducing or eliminating the formation of bubbles in a droplet during droplet operations on a droplet actuator, comprising performing droplet operations on the droplet using the droplet actuator of claim 1.

28. The method of claim 27, wherein the droplet operations comprise droplet splitting.

29. The method of claim 27, wherein the droplet operations comprise droplet merging.

30. The method of claim 27, wherein the droplet operations comprise transporting the droplet.

31. The method of claim 27, wherein the droplet operations comprise droplet dispensing.

32. A microfluidics system programmed to execute the method of claim 27 on a droplet actuator comprising:
a. a top substrate and a bottom substrate separated to form a droplet operations gap, wherein the bottom substrate comprises a first rail and a second rail separated to form a droplet operations channel;
b. droplet operations electrodes atop a side of the first rail, wherein the side of the first rail faces the droplet operations channel;
c. one or more counter-electrodes atop a side of the second rail, wherein the side of the second rail faces the droplet operations channel; and
wherein the droplet operations electrodes are arranged to maintain contact between a droplet and the one or more counter-electrodes during droplet operations.

33. A storage medium comprising program code embodied in the medium for executing the method of claim 27 on a droplet actuator comprising:
a. a top substrate and a bottom substrate separated to form a droplet operations gap, wherein the bottom substrate comprises a first rail and a second rail separated to form a droplet operations channel;
b. droplet operations electrodes atop a side of the first rail, wherein the side of the first rail faces the droplet operations channel;
c. one or more counter-electrodes atop a side of the second rail, wherein the side of the second rail faces the droplet operations channel; and
wherein the droplet operations electrodes are arranged to maintain contact between a droplet and the one or more counter-electrodes during droplet operations.

34. A microfluidics system comprising a droplet actuator coupled to a processor, wherein the processor executes program code embodied in a storage medium for executing the method of claim 27 on a droplet actuator comprising:
a. a top substrate and a bottom substrate separated to form a droplet operations gap, wherein the bottom substrate comprises a first rail and a second rail separated to form a droplet operations channel;
b. droplet operations electrodes atop a side of the first rail, wherein the side of the first rail faces the droplet operations channel;
c. one or more counter-electrodes atop a side of the second rail, wherein the side of the second rail faces the droplet operations channel; and
wherein the droplet operations electrodes are arranged to maintain contact between a droplet and the one or more counter-electrodes during droplet operations.
